(19) United States
(12) Patent Application Publication
(10) Pub. No.: US 2008/0102698 A1
(43) Pub. Date: May 1, 2008

(54) Electrical connector

(75) Inventor: Yu-Sheng Chen, Keelung (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: LOTES CO., LTD.

(21) Appl. No.: 11/590,907

(22) Filed: Nov. 1, 2006

(51) Int. Cl. H01R 13/648

(52) U.S. Cl. 439/607

(57) ABSTRACT

The present invention discloses an electrical connector, comprising an insulating body whose front end protrudes to form a mating portion to mate with mating electronic devices; a plurality of electrical terminals, and a shielding metal sheet capable of encompassing the insulating body. The present invention also discloses an electrical connector assembly, comprising: a first connector having an insulating body which is protrudingly disposed with a mating portion to mate with electronic device and a plurality of electrical terminals; a second connector capable of connecting with the first connector; and a shielding metal sheet which can at least encompass the first connector. The present invention can effectively shield the electrical connector from the interfering of external electronic signals to achieve normal input and output of electronic signals.

### FIELD OF THE INVENTION

The present invention relates to an electrical connector and in particular to an electrical connector with low electromagnetic interference.

### BACKGROUND OF THE INVENTION

With reference to FIG. 1, the conventional electrical connector 40 usually comprises an insulating body 20 and electrical terminals 30 accommodated therein. The front end of the insulating body 20 is disposed with a protruding portion 50. On end of the electrical terminal 30 is connected with an circuit board (not shown) and the other end is insertingly connected with a mating electronic device (not shown) through the protruding portion 50 of the insulating body 20 to achieve electrical connection between electronic devices and a circuit board.

However, after the electrical connector 40 is mated with a circuit board, significant interferences occur between the large numbers of electronic devices on the circuit board. Because there is no electromagnetic shielding for the electrical connector 40, it is also affected by the electromagnetic interference, leading to the input/output electronic signals being affected and even the operation of the mating electronic devices being paralyzed.

It is therefore necessary to design a new electrical connector capable of shielding the electrical connector 40 from electromagnetic interference.

### SUMMARY OF THE INVENTION

The object of the present is to provide an electrical connector capable of achieving effective shielding and reducing electromagnetic interference.

To achieve the aforementioned object, an electrical connector according to the present invention comprises: an insulating body whose front end protrudes to form a mating portion to mate with mating electronic devices; a plurality of electrical terminals, and a shielding metal sheet capable of encompassing the insulating body.

To achieve the aforementioned object, the present invention further provides an electrical connector assembly, comprising: a first connector having an insulating body which is protrudingly disposed with a mating portion to mate with electronic device and a plurality of electrical terminals; a second connector capable of connecting with the first connector; and a shielding metal sheet which can at least encompass the first connector.

Compared with the conventional art, the electrical connector according to the present invention can effectively shield the electrical connector from the interfering of external electronic signals to achieve normal input and output of electronic signals.

### BRIEF DESCRIPTION OF THE DRAWINGS

The present invention can be more fully understood by reference to the following description and accompanying drawings, in which:

FIG. 1 schematically illustrates a perspective view of a conventional electrical connector;

FIG. 2 schematically illustrates a perspective view of the electrical connector assembly according to the present invention;

FIG. 3 schematically illustrates a perspective view of the electrical connector assembly according to the present invention from another view angle;

FIG. 4 schematically illustrates a perspective view of the electrical connector assembly according to the present invention from yet another view angle;

FIG. 5 schematically illustrates a decomposed view of the electrical connector assembly according to the present invention; and

FIG. 6 schematically illustrates an exploded perspective view of the electrical connector assembly according to the present invention.

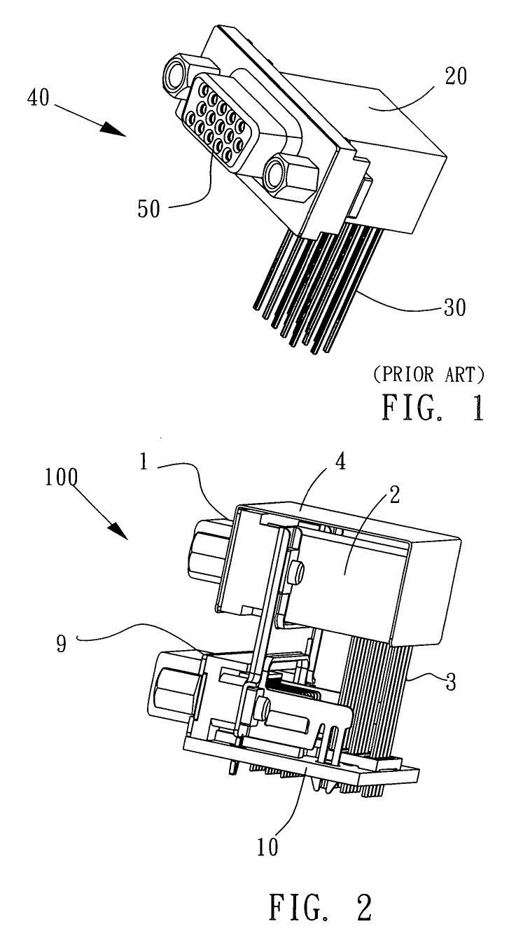

### DETAILED DESCRIPTION OF THE INVENTION

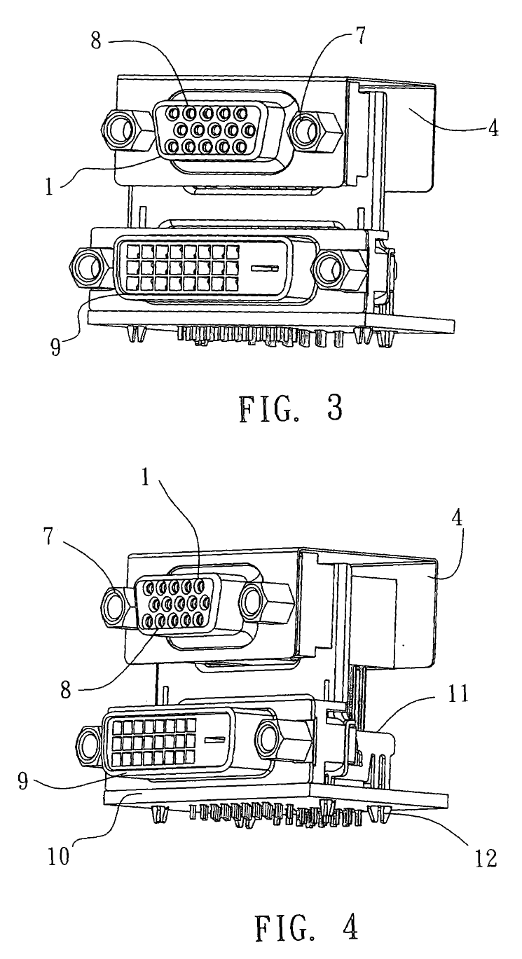

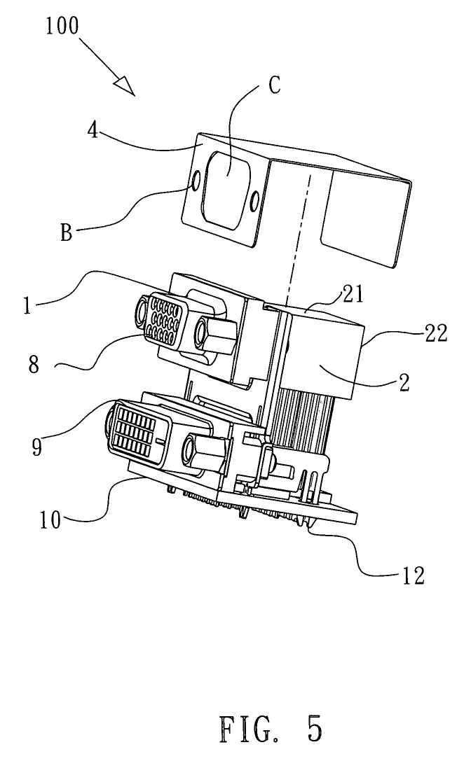

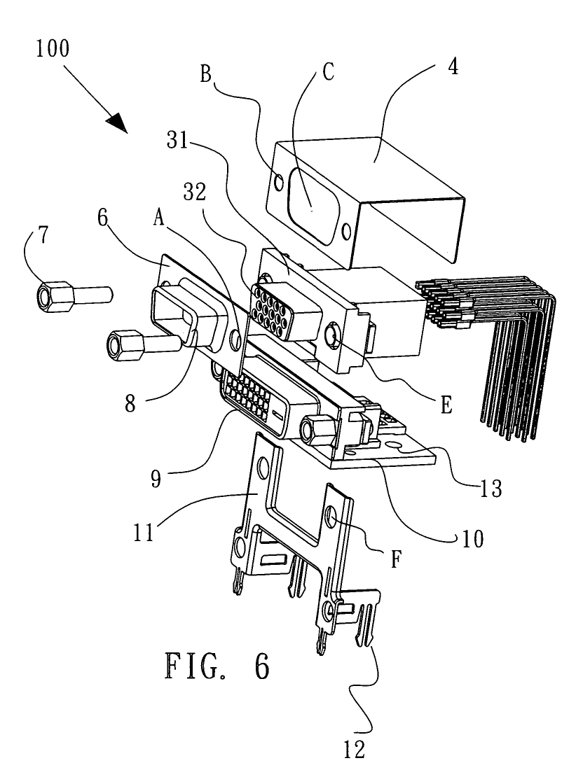

With reference to FIGS. 2 to 6, the electrical connector assembly 100 comprises a first electrical connector 1 and a second electrical connector 9, wherein the first electrical connector 1 and the second electrical connector 9 comprise an insulating body 2 and a plurality of electrical terminals 3, respectively. The insulating body 2 includes a front face 31, which is protrudingly provided with a mating portion 32 to mate with external mating electronic device (not shown). Furthermore, the insulating body 2 is disposed with a plurality of accommodating holes (not labeled in the figures). One end of each electrical terminal 3 is received in the accommodating hole and the other end is exposed therefrom, which is a conventional art and will not be discussed here furthermore.

The first electrical connector 1 and the front face 31 for mating with electronic devices are encompassed with a metal housing 6 to effectively protect the insulating body 2, preventing the insulating body 2 from being damaged after the repetitive plugging and unplugging of the mating electronic devices. The metal housing 6 is further disposed with a protruding portion 8, which accommodates the mating portion 32 of the electrical terminal 3, to mate with corresponding electronic devices.

The shielding metal sheet 4 encompasses the upper face 21 and rear face 22 of the insulating body 2. The shielding metal sheet 4 may also encompass the front face of the metal housing 6 (in the case of without the metal housing 6, the shielding metal sheet 4 may directly encompass the front face 32 and be secured onto the insulating body 2 through a screw 7) to form electrical connection therebetween, and be secured onto the insulating body 2 through a fastening structure, wherein the fastening structure is, for example but not limited to, the hole A provided on the metal housing 6, the B hole provided on the shielding metal sheet 6, and the screw 7. The metal housing 6 is provided with the hole A and the corresponding hole B is provided on the shielding metal sheet 4; the diameter of the hole B on the shielding metal sheet 4 is smaller than that of the hole A on the metal housing 6 to prevent the shielding metal sheet 4 from loosening up after it is secured on the metal housing 6.

A corresponding hole E is provided on the insulating body 2 for the inserting of the screw 7. The screw 7 may be, in sequence, inserted into the hole A on the metal housing 6, the hole B on the shielding metal sheet 4, and the corresponding hole E on the insulating body 2, and finally secured onto the insulating body 2 such that the metal housing 6 and the shielding metal sheet 4 may be secured onto the insulating body 2. The shielding metal sheet 4 is further provided with a hole C corresponding to the protruding portion 8 such that the hole C may be operated with the protruding portion 8.

The first electrical connector 1 is secured onto circuit board 10 through a steel frame 11. The hole F provided on the steel frame 11 may be passed through the end of the screw 7 of the insulating body 2 to be secured onto the insulating body 2. The end of the steel frame 11 is further provided with a plurality of inserting pins 12 to insert into the corresponding holes 13 on the circuit board 10, such that the first electrical connector 11 may be securingly fastened onto the circuit board 10. Thus, the steel frame 11 is abutted against the side of the insulating body 2 and the steel frame 11 is fastened by the screw 7 provided on the insulating body 2 without the need of other auxiliary parts for fastening and thus without occupying too much space.

The first electrical connector 1 is electrically connected with the circuit board 10 through one end of the electrical terminal 3, and the other end of the electrical terminal 3 is mated with mating electronic devices (not shown) to achieve the electrical connection between the circuit board 10 and the mating electronic devices (not shown) and the input/output of electronic signals. Under usual circumstance, there exist a large number of electronic devices on the circuit board 10 and thus the input/output of the electronic signals are bound to be affected by the electromagnetic interference from the massive electronic signals. The shielding metal sheet 4 encompassing the insulating body 2 can effectively shield the input/output signals from the interfering by the electronic signals coming from other electronic devices, such that the electronic signals may input/output normally. The second electrical connector 9 is disposed below the first electrical connector 1, wherein the second electrical connector 9 is assembled with the steel frame 11, which is then fastened with the circuit board 10. The first connector 1 and the second connector 9 form the electrical connector assembly 100. The shielding metal sheet 4 can also shield the second electrical connector 9 from the interfering of electronic signals.

The electromagnetic shielding structure according to the present invention is the shielding metal sheet 4. Certainly, the shielding structure may also be a metal woven net, which can also achieve the same aforementioned functions and will be discussed here furthermore.

While the invention has been described with reference to the a preferred embodiment thereof, it is to be understood that modifications or variations may be easily made without departing from the spirit of this invention, which is defined by the appended claims.

1. An electrical connector, comprising an insulating body whose front end protrudes to form a mating portion to mate with mating electronic devices;
a plurality of electrical terminals;
a shielding metal sheet encompassing the insulating body; and
a metal housing having a protruding portion to mate with electronic devices, a front face of the insulating body is encompassed with the metal housing, the shielding metal sheet encompasses the upper face and a rear face of the insulating body, the shielding metal sheet has a hole corresponding with the protruding portion.

2-3. (canceled)

4. The electrical connector as defined in claim 1, wherein the metal housing and the shielding metal sheet are contacted to form electrical connection.

5. The electrical connector as defined in claim 1, wherein the metal housing and the shielding metal sheet are secured onto the insulating body through a fastening structure.

6. The electrical connector as defined in claim 5, wherein the fastening structure comprises holes provided on the metal housing and the shielding metal sheet, and a screw which is inserted through the holes on the metal housing and the shielding metal sheet to secure onto the insulating body.

7. The electrical connector as defined in claim 6, wherein the diameter of the hole provided on the shielding metal sheet is smaller than that provided on the metal housing.

8. (canceled)

9. The electrical connector as defined in claim 1, wherein the shielding metal sheet encompasses at least the front face, upper face, and rear face of the insulating body.

10. The electrical connector as defined in claim 1, wherein the shielding metal sheet may be a metal woven net.

11. An electrical connector assembly, comprising
a first connector having an insulating body which is protrudingly disposed with a mating portion to mate with electronic device and a plurality of electrical terminals;
a second connector capable of connecting with the first connector;
a shielding metal sheet which at least encompasses the first connector; and
a metal housing encompassing a front face, an upper face, and a rear face of the insulating body, the metal housing has a protruding portion to mate with electronic devices and the shielding metal sheet is provided with a hole corresponding with the protruding portion.

12. The electrical connector as defined in claim 11, wherein the shielding metal sheet encompasses the first electrical connector and the second electrical connector.

13. (canceled)

14. The electrical connector as defined in claim 11, wherein the metal housing and the shielding metal sheet are contacted to form electrical connection.

15. The electrical connector as defined in claim 11, wherein the metal housing and the shielding metal sheet are secured onto the insulating body through a fastening structure.

16. The electrical connector as defined in claim 15, wherein the fastening structure comprises holes provided on the metal housing and the shielding metal sheet, and a screw which is inserted through the holes on the metal housing and the shielding metal sheet to secure onto the insulating body.

17. The electrical connector as defined in claim 16, wherein the diameter of the hole provided on the shielding metal sheet is smaller than that provided on the metal housing.

18. (canceled)

19. The electrical connector as defined in claim 11, wherein the shielding metal sheet encompasses at least the front face, upper face, and rear face of the insulating body of the first electrical connector.

20. The electrical connector as defined in claim 11, wherein the shielding metal sheet may be a metal woven net.
